(19) United States
(12) Patent Application Publication
(10) Pub. No.: US 2010/0253707 A1
(43) Pub. Date: Oct. 7, 2010

(54) DISPLAY DEVICE

(75) Inventor: Hidekazu Miyake, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/729,750

(22) Filed: Mar. 23, 2010

(30) Foreign Application Priority Data
Apr. 3, 2009 (JP) 2009-091535

(51) Int. Cl. G09G 3/32; G09G 5/10

(52) U.S. Cl. 345/690; 345/82

(57) ABSTRACT

There is provided a display device capable of reducing a horizontal crosstalk. The display device includes: a plurality of light emitting elements two-dimensionally arranged in a horizontal direction and a vertical direction, and including an anode electrode, a light emitting layer, and a cathode electrode; and a voltage generating circuit applying a correction voltage corresponding to a video signal of one horizontal line to the cathode electrode.

### BACKGROUND OF THE INVENTION

1. Field of the Invention

The present invention relates to a display device including a light emitting element.

2. Description of the Related Art

In recent years, in the field of a display device displaying an image, a display device using a current drive type optical element whose light emission luminance changes in accordance with the value of a flowing current, for example, an organic EL (electroluminescence) element as a light emitting element of a pixel has been developed and progressively commercialized. Unlike a liquid crystal element and the like, the organic EL element is a self-luminous element. Thus, a light source (backlight) is unnecessary in the display device using the organic EL element (organic EL display device), and this enables thinning and high luminance in comparison with a liquid crystal display device in which the light source is necessary. In particular, in the case where the active matrix method is employed as a driving method, it is possible to light and hold each pixel, and it is possible to realize low power consumption. Thus, the organic EL display device is expected to become the mainstream of a flat panel display in the next generation.

Similarly to the liquid crystal display device, in the organic EL display device, there are the simple (passive) matrix method and the active matrix method as the driving method, and organic EL elements line-sequentially emit light in both of the methods. Thus, in the case where the total luminance (current value) of pixels of one line is different for each of the lines, even when signal voltages of the same gray scale are applied, a phenomenon in which actual light emission luminance is different for each of the lines (horizontal crosstalk) is generated, and there is an issue that deterioration of image quality occurs.

Thus, there have been attempts to prevent the horizontal crosstalk. For example, in Japanese Unexamined Patent Publication Nos. 2006-251602 and 2005-538042, and International Publication WO 2003/027999, the methods to correct a voltage drop caused by wiring resistance of a power source line are disclosed.

### SUMMARY OF THE INVENTION

However, it is difficult to completely eliminate the horizontal crosstalk only by correcting the voltage drop caused by the wiring resistance of the power source line, and further measures are demanded.

In view of the forgoing, it is desirable to provide a display device capable of reducing a horizontal crosstalk by a new method.

According to an embodiment of the present invention, there is provided a display device including: a plurality of light emitting elements two-dimensionally arranged in a horizontal direction and a vertical direction. The plurality of light emitting elements include an anode electrode, a light emitting layer, and a cathode electrode. The display device according to the embodiment of the present invention includes a voltage generating circuit applying a correction voltage corresponding to a video signal of one horizontal line to the cathode electrode.

In the display device according to the embodiment of the present invention, the correction voltage corresponding to the video signal of one horizontal line is applied to the cathode electrode. Thereby, when a signal voltage corresponding to the video signal is applied to a signal line, even in the case where a voltage of the cathode electrode is changed due to a line capacity between the signal line and the cathode electrode, it is possible to reduce the change by applying the correction voltage.

According to the display device of the embodiment of the present invention, since the change of the cathode voltage due to the line capacity between the signal line and the cathode electrode is reduced by applying the correction voltage, it is possible to reduce a horizontal crosstalk caused by the change of the cathode voltage.

Other and further objects, features and advantages of the invention will appear more fully from the following description.

### BRIEF DESCRIPTION OF THE DRAWINGS

FIG. 1 is a schematic configuration view of a display device according to an embodiment of the present invention.

FIG. 2 is a configuration view of a pixel circuit array.

FIG. 3 is a conceptual view for explaining light intensity distribution on a display screen.

FIG. 4 is a characteristic view illustrating an example of I-L characteristics of an organic EL element.

FIG. 5 is a characteristic view illustrating an example of V_{gs}-I_{d} characteristics of the organic EL element.

FIG. 6 is a schematic view illustrating an example of an LUT used for correcting a cathode voltage.

FIG. 7 is a configuration view of a pixel circuit array according to a comparative example.

FIG. 8 is a waveform diagram for explaining a change of the cathode voltage when the organic EL element is driven with the pixel circuit array of FIG. 7.

FIG. 9 is an equivalent circuit view of the pixel circuit array of FIG. 7.

FIG. 10 is a waveform diagram for explaining a correction period of the cathode voltage.

FIG. 11 is a waveform diagram for explaining an example of operation of the display device of FIG. 1.

FIG. 12 is a schematic configuration view of a modification of the display device of FIG. 1.

FIG. 13 is a plan view illustrating the schematic configuration of a module including the display device of the above embodiment.

FIG. 14 is a perspective view illustrating an appearance a first application example of the display device of the above embodiment.

FIG. 15A is a perspective view illustrating an appearance of a second application example as viewed from the front side, and FIG. 15B is a perspective view illustrating the appearance as viewed from the rear side.

FIG. 16 is a perspective view illustrating an appearance of a third application example.

FIG. 17 is a perspective view illustrating an appearance of a fourth application example.

FIG. 18A is an elevation view of a fifth application example unclosed, FIG. 18B is a side view thereof, FIG. 18C is an elevation view of the fifth application example closed, FIG. 18D is a left side view thereof, FIG. 18E is a right side view thereof, FIG. 18F is a top face view thereof, and FIG. 18G is a bottom face view thereof.

### DETAILED DESCRIPTION OF THE PREFERRED EMBODIMENT

An embodiment of the present invention will be hereinafter described in detail with reference to the drawings. The description will be made in the following order:

### 1. Embodiment

1.1 Schematic configuration of display device
1.2 Horizontal crosstalk
1.3 Actions of display device
1.4 Operations and effects

### 2. Modification

3. Module and application examples

### 1. Embodiment

### 1.1 Schematic Configuration of Display Device

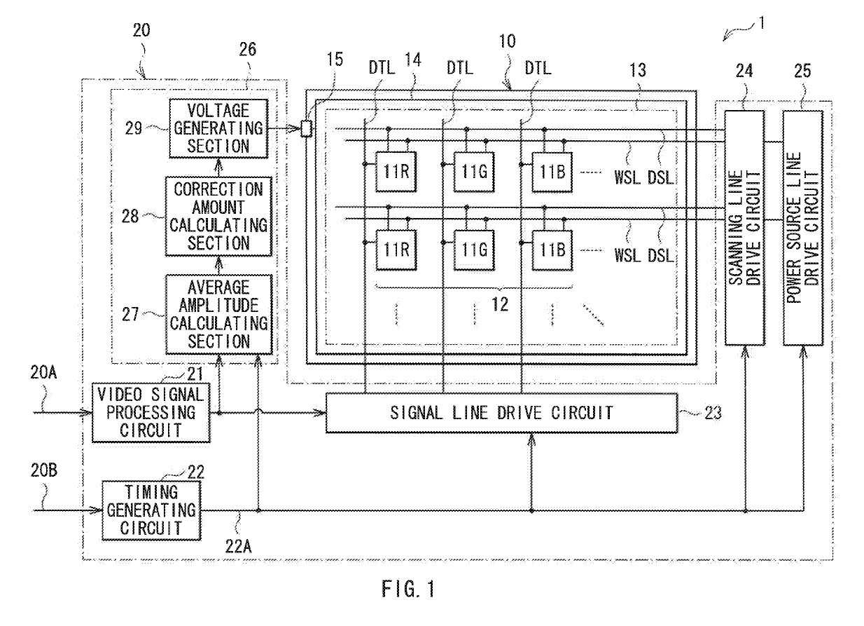

FIG. 1 illustrates the schematic configuration of a display device 1 according to a first embodiment of the present invention. The display device 1 includes a display panel 10, and a drive circuit 20 driving the display panel 10. The display panel 10 includes, for example, a pixel circuit array 13 in which a plurality of organic EL elements 11R, 11G, and 11B (light emitting elements) are arranged in a matrix. In this embodiment, for example, the three organic EL elements 11R, 11G, and 11B adjacent to each other constitute a pixel 12. Hereinafter, “organic EL element 11” will be appropriately used as a general term for the organic EL elements 11R, 11G, and 11B. The drive circuit 20 includes, for example, a video signal processing circuit 21, a timing generating circuit 22, a signal line drive circuit 23, a scanning line drive circuit 24, a power source line drive circuit 25, and a cathode voltage generating circuit 26.

[Pixel Circuit Array]

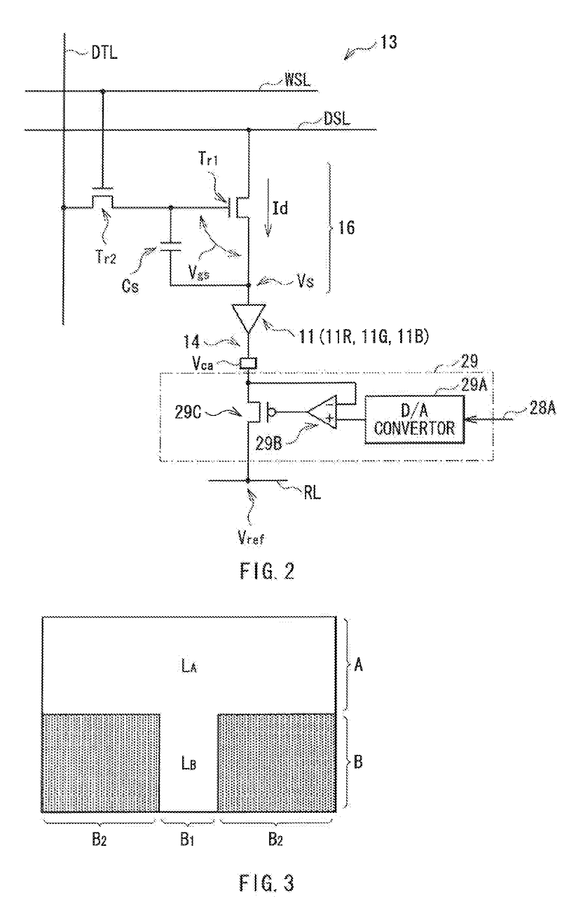

FIG. 2 illustrates an example of the circuit configuration of the pixel circuit array 13. The pixel circuit array 13 is a region corresponding to a display region of the display panel 10. For example, as illustrated in FIGS. 1 and 2, the pixel circuit array 13 includes a plurality of scanning lines WSL arranged in a row direction, a plurality of signal lines DTL arranged in a column direction, and a plurality of power source lines DSL arranged along the scanning lines WSL. Correspondingly to each intersection of each scanning line WSL and each signal line DTL, the plurality of organic EL elements 11 and pixel circuits 16 are arranged in a matrix (two-dimensional arrangement). The pixel circuit 16 is composed of, for example, a drive transistor Tr₁, a write transistor Tr₂, and a retention capacity Cs, and its circuit configuration is 2Tr₁C type. The drive transistor Tr₁ and the write transistor Tr₂ are, for example, formed of an N-channel MOS thin film transistor (TFT). The type of the TFT is not specifically limited. The TFT may have, for example, an unstaggered structure (so-called bottom gate type), or a staggered structure (top gate type). The drive transistor Tr₁ or the write transistor Tr₂ may be a P-channel MOS TFT.

In the pixel circuit array 13, each signal line DTL is connected to an output terminal (not illustrated in the figure) of the signal line drive circuit 23, and a drain electrode (not illustrated in the figure) of the write transistor Tr₂. Each scanning line WSL is connected to an output terminal (not illustrated in the figure) of the scanning line drive circuit 24, and a gate electrode (not illustrated in the figure) of the write transistor Tr₂. Each power source line DSL is connected to an output terminal (not illustrated in the figure) of the power source line drive circuit 25, and a drain electrode (not illustrated in the figure) of the drive transistor Tr₁. A source electrode (not illustrated in the figure) of the write transistor Tr₂ is connected to a gate electrode (not illustrated in the figure) of the drive transistor Tr₁, and one end of the retention capacity Cs. A source electrode (not illustrated in the figure) of the drive transistor Tr₁, and the other end of the retention capacity Cs are connected to an anode electrode (not illustrate in the figure) of the organic EL elements 11. A cathode electrode 14 (refer to FIGS. 1 and 2) of the organic EL elements 11 is connected to a cathode electrode terminal 15 provided in the display panel 10, and a reference potential line RL through a voltage generating section 29 which will be described later. The cathode electrode 14 is used as a common electrode for each of the organic EL elements 11. For example, as illustrated in FIG. 1, the cathode electrode 14 is continuously formed over the whole pixel circuit array 13 (display region), and is in the shape of a flat plate.

[Drive Circuit]

Next, each circuit in the drive circuit 20 provided on the periphery of the pixel circuit array 13 will be described with reference to FIGS. 1 and 2. The video signal processing circuit 21 performs a predetermined correction on a digital video signal 20A input from the external, and converts the corrected video signal into an analogue signal to output the analogue signal to the signal line drive circuit 23 and an average amplitude calculating section 27 which will be described later. Examples of the predetermined correction include a gamma correction and an overdrive correction. The timing generating circuit 22 controls the signal line drive circuit 23, the scanning line drive circuit 24, the power source line drive circuit 25, and the cathode voltage generating circuit 26 to operate in conjunction with each other. The timing generating circuit 22 outputs, for example, a control signal 22A to these circuits in response to (in synchronization with) a synchronization signal 20B input from the external.

The signal line drive circuit 23 applies the analogue video signal (signal voltage corresponding to the video signal 20A) input from the video signal processing circuit 21 to each signal line DTL, and writes the analogue video signal in the selected organic EL element 11. For example, the signal line drive circuit 23 may output a signal voltage V_{sig} corresponding to the video signal 20A, and a voltage V_{ofs} applied to the gate of the drive transistor Tr₁ at the time of light extinction of the organic EL element 11. Here, the voltage V_{ofs} has a voltage value (constant value) lower than that of a threshold voltage Vₑ₁ of the organic EL element 11, and higher than a minimum voltage of the signal voltage V_{sig}.

The scanning line drive circuit 24 sequentially selects one scanning line WSL from the plurality of scanning lines WSL in response to (in synchronization with) the input of the control signal 22A. For example, the scanning line drive circuit 24 may output a voltage Vₒₙ applied when turning on the write transistor Tr₂, and a voltage V_{off} applied when turning off the write transistor Tr₂. Here, the voltage Vₒₙ has a voltage value (constant value) equal to or higher than that of an on-voltage of the write transistor Tr₁. The voltage V_{off} has a voltage value (constant value) lower than that of an on-voltage of the write transistor Tr₂.

The power source line drive circuit 25 controls light emission and light extinction of the organic EL element 11 in response to (in synchronization with) the input of the control signal 22A. The power source line drive circuit 25 may output, for example, a voltage V_{cc} applied when flowing a current to the drive transistor Tr₁, and a voltage Vᵢₙᵢ applied when flowing no current to the write transistor Tr₁. Here, the voltage Vᵢₙᵢ has a voltage value (constant value) lower than that of a voltage (Vₑ₁+V_{ca}) obtained by adding a threshold voltage Vₑ₁ of the organic EL element 11, and a cathode voltage V_{ca} of the organic EL element 11. The voltage V_{cc} has a voltage value (constant value) equal to or higher than that of the voltage (Vₑ₁+V_{ca}).

The cathode voltage generating circuit 26 applies a voltage corresponding to the video signal of one horizontal line (cathode voltage V_{ca}) to the cathode electrode 14 through the cathode electrode terminal 15 in the display panel 10. For example, as illustrated in FIG. 1, the cathode voltage generating circuit 26 includes the average amplitude calculating section 27, a correction amount calculating section 28, and a voltage generating section 29.

The average amplitude calculating section 27 calculates, from the video signal 20A of one horizontal line, the signal voltage V_{sig} of one horizontal line output to the plurality of signal lines DTL. Next, by obtaining a difference between the signal voltage V_{sig} of one horizontal line and the voltage V_{ofs} the average amplitude calculating section 27 calculates an amplitude H of the signal voltage V_{sig} of one horizontal line, and then calculates an average amplitude H_{avg} of one horizontal line. The average amplitude H_{avg} is obtained, for example, by dividing a total of the signal voltage V_{sig} of one horizontal line by the number of pixels included in one horizontal line. At the time of calculating the average amplitude H_{avg}, for example, some sort of calculation may be performed on the signal voltage V_{sig} in accordance with the magnitude of the signal voltage V_{sig}.

The correction amount calculating section 28 calculates a correction voltage V_{c} applied to the cathode electrode 14 in response to the average amplitude H_{avg}. Hereinafter, after describing a background of the calculation of the correction voltage V_{c}, the specific description will be made on the calculation of the correction voltage V_{c}.

[Background]

FIG. 3 illustrates an example of a video displayed on the display panel 10. In FIG. 3, the case is illustrated where an upper half A of the video has an entirely-white display, and a lower half B of the video has a white display in a portion B₁, and has a black display in a portion B₂ which is a part other than the portion B₁. The signal voltages V_{sig} having the same magnitude are applied to the pixel circuit 16 corresponding to the white display of the upper half A, and to the pixel circuit 16 corresponding to the white display of the portion B₁ in the lower half B through the signal line DTL.

In the case where the video as described above is displayed on the display panel 10, the white display of the upper half A and the white display of the portion B₁ in the lower half B are different due to the influence of a horizontal crosstalk caused by the change of the cathode voltage V_{ca}. Specifically, the white display of the upper half A is darker than the white display of the portion B₁ in the lower half B, and its darkness degree is in a correlation with the ratio of the portion B₁ in the lower half B occupying the lower half B. For example, a luminance L_{A} of the white display of the upper half A is in a correlation with L_{B}/(L₁/(L₁+L₂)), where the following definitions are assigned to the symbols, respectively. That is, as the ratio of the white display occupying one horizontal line is increased, the luminance of the white display is reduced.

L1: a width of the portion B₁ in the lower half B

L₂: an entire width of the portion B₂ which is a part other than the portion B₁ in the lower half B

L₁+L₂: a lateral width of the display region in the display panel 10

L₁/(L₁+L₂): ratio of the portion B₁ occupying the lower half B

L_{A}' luminance of the white display of the upper half A

L_{B}: luminance of the white display of the portion B₁ in the lower half B

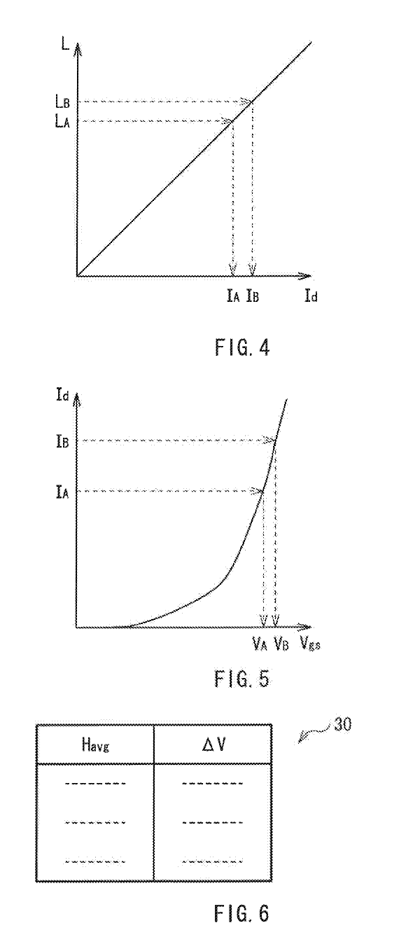

Next, by utilizing I-L characteristics and V_{gs}-I_{d} characteristics of the drive transistor Tr₁, the relationship of the luminance L of the white display and a voltage V_{gs} between the gate and the source will be described. FIG. 4 illustrates an example of the I-L characteristics of the drive transistor Tr₁. FIG. 5 illustrates an example of the V_{gs}-I_{d} characteristics of the drive transistor Tr₁. From FIG. 4, it is possible to derive a current value I_{A} corresponding to L_{A}, and a current value I_{B} corresponding to L_{B}. From FIG. 5, it is possible to derive a voltage V_{A} between the gate and the source corresponding to the current value I_{A}, and a voltage V_{B} between the gate and the source corresponding to the current value Iₙ.

Thus, to equalize the luminance L_{A} and the luminance L_{B} to each other, irrespective of the ratio of the white display occupying one horizontal line, it is understood that V_{ca} is necessarily corrected so that V_{gs} is identical in all the pixel circuits 16 in which the magnitude of V_{sig} is identical to each other.

In the above case, for example, the intended signal voltage V_{sig} may be applied to the signal line DTL so that the voltage V_{gs} between the gate and the source becomes V_{A}, that is, the voltage V_{gs} is reduced by (V_{B}−V_{A}) in the pixel circuit 16 corresponding to the white display of the portion B₁ in the lower half B. Alternatively, for example, the intended signal voltage V_{sig} may be applied to the signal line DTL so that the voltage V_{gs} becomes (V_{A}+V_{B})/2 in the pixel circuit 16 corresponding to the white display of the portion B₁ in the lower half B, and the pixel circuit 16 corresponding to the white display of the upper half A. In the latter case, the intended signal voltage V_{sig} is applied to the signal line DTL so that the voltage V_{gs} is reduced by (V_{B}−V_{A})/2 in the pixel circuit 16 corresponding to the white display of the portion B₁ in the lower half B. The intended signal voltage V_{sig} is applied to the signal line DTL so that the voltage V_{gs} is increased by (V_{B}−V_{A})/2 in the pixel circuit 16 corresponding to the white display of the upper half A.

[Calculation of Correction Voltage V_{c}]

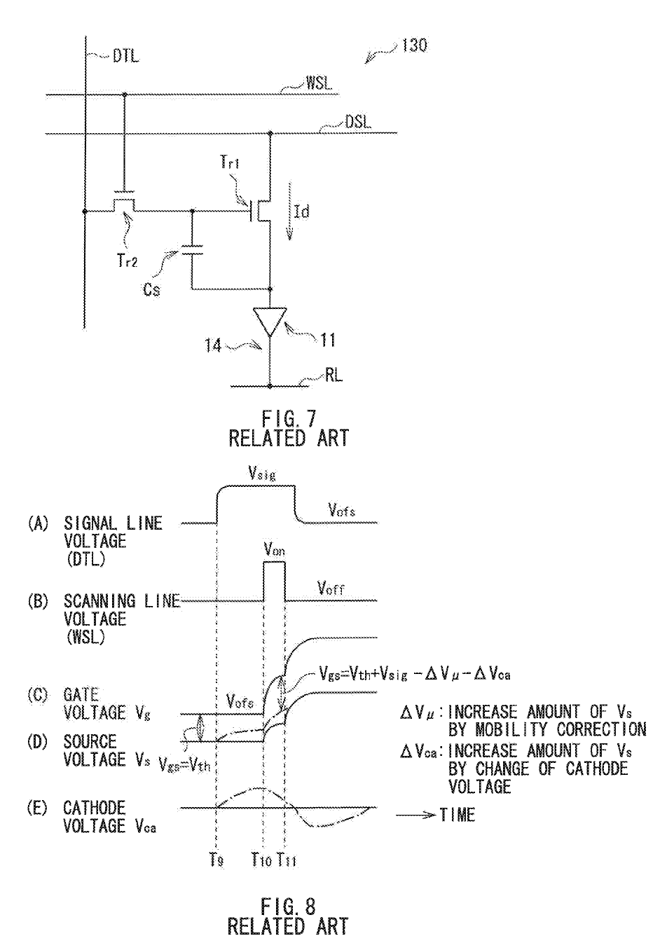

Next, an example of a specific method of correcting the cathode voltage V_{ca} will be described. In this embodiment, the correction amount calculating section 28 previously includes an LUT (lookup table) 30 associating the average amplitude H_{avg} (or the information on the average amplitude H_{avg}), and a correction amount ΔV to the reference voltage V_{ref} of the cathode electrode 14 (refer to FIG. 6). The correction amount calculating section 28 extracts, from the LUT 30, the correction amount ΔV corresponding to the average amplitude H_{avg} calculated from the video signal 20A, and calculates the value of the correction voltage V_{c} based on the extracted correction amount ΔV and the reference voltage V_{ref}. The value of the correction voltage V_{c} is obtained, for example, by adding the reference voltage V_{ref} and the correction voltage V_{c}. In relation to the reference voltage V_{ref}, a sign of the correction voltage V_{c} may be a positive polarity, or a negative polarity.

When calculating the correction voltage V_{c}, it is preferable to set up the average amplitude H_{avg} to become the reference of the correction amount ΔV, that is, the average amplitude H_{avg} in which the correction amount ΔV is zero. For example, as the value of the average amplitude H_{avg} in which the correction amount ΔV is zero, a value when the ratio of the white display occupying one horizontal line is 50% (H_{avg}(50%)) is set up. In the case of such a setting, it is possible to approximately equalize the average luminance of the video before being corrected and the video after being corrected.

In the LUT 30, as the value of the average amplitude H_{avg}, for example, values when the ratio of the white display occupying one horizontal line is 10%, 20%, . . . , 100% (intervals of every 10%) may be prepared. However, in this case, when the ratio of the white display occupying one horizontal line is 13% or the like, there is a case where the value of the average amplitude H_{avg} corresponding to the ratio which does not exist in the LUT 30 is derived in the average amplitude calculating section 27. In that case, the correction amount calculating section 28 may calculate the necessary correction value ΔV by using the linear interpolation method or the like. The value of the average amplitude H_{avg} included in the LUT 30 may be previously obtained by prediction through the use of numerical calculation or the like. However, the value of the average amplitude H_{avg} is preferably obtained by actual measurement, and more preferably obtained for individual devices.

The correction amount calculating section 28 generates a digital signal corresponding to the correction voltage V_{c} calculated as described above, and outputs the digital signal to the voltage generating section 29 in the subsequent stage.

The voltage generating section 29 generates the correction voltage V_{c} from the value of the correction voltage V_{c} calculated in the correction amount calculating section 28, and applies the correction voltage V_{c} to the cathode electrode 14. For example, as illustrated in FIG. 2, the voltage generating section 29 includes a D/A convertor 29A, an operational amplifier 29B, and a transistor 29C. The operational amplifier 29B and the transistor 29C correspond to a specific example of “constant voltage circuit” of the embodiment of the present invention.

The D/A convertor 29A converts the digital signal into an analogue signal, and outputs the analogue signal. The D/A convertor 29A generates, for example, a correction pulse including the correction voltage V_{c} as a wave-height value from the correction voltage V_{c} as the digital signal input from the correction amount calculating section 28, and outputs the correction pulse. The operational amplifier 29B is used, for example, to output the voltage identical to the input voltage (correction voltage V_{c}) from the D/A convertor 29A. The operational amplifier 29B may be used to amplify the input voltage from the D/A convertor 29A, and to output the amplified voltage. The transistor 29C is, for example, a p-channel MOS-FET.

An input terminal of the D/A convertor 29A is connected to an output terminal of the correction amount calculating section 28, and an output terminal of the D/A convertor 29A is connected to one input terminal of the operational amplifier 29B. An output terminal of the operational amplifier 29B is connected to a gate of the transistor 29C, and the other input terminal of the operational amplifier 29B is connected to a source or a drain of the transistor 29C and the cathode electrode terminal 15. The source or the drain of the transistor 29C which is not connected to the cathode electrode terminal 15 is connected to the reference potential line RL. Thereby, a negative feedback of the operational amplifier 29B is operated so that the cathode electrode terminal 15 has the voltage identical to the input voltage (correction voltage V_{c}) from the D/A convertor 29A. The current I_{d} flowing through the organic EL element 11 flows to the reference potential line RL through the transistor 29C. In addition, after the description is made on the horizontal crosstalk next, the timing and the period when the correction voltage V_{c} is output from the voltage generating section 29 will be described in detail.

### 1.2 Horizontal Crosstalk

Next, occurrence causes of the horizontal crosstalk will be described. FIG. 7 illustrates the configuration of a pixel circuit array 130 in a typical organic EL display. Part A to part E of FIG. 8 illustrate an example of the timing chart when the organic EL element 11 is driven by the pixel circuit array 130 of FIG. 7. The pixel circuit array 130 is formed by eliminating the voltage generating section 29 and connecting the cathode electrode 14 of the organic EL element 11 to the reference potential line RL in the pixel circuit array 13 of this embodiment. In the same manner as this embodiment, the cathode electrode 14 is used as a common electrode for each of the organic EL elements 11.

First, typically-known causes will be described. When the signal voltage V_{sig} in response to the video signal is output to each signal line DTL, and the voltage Vₒₙ is output to one scanning line WSL (part A and part B of FIG. 8), the write transistor Tr₂ is turned on, and the electrical charge in response to the signal voltage pulse is stored in the retention capacity Cs. Next, when the voltage V_{off} is output to one scanning line WSL (part B of FIG. 8), the write transistor Tr₂ is turned off, and the voltage V_{gs} between the gate and the source of the drive transistor Tr₁ is retained by the retention capacity Cs. Thereby, the constant current I_{d} determined by V_{gs} flows to the organic EL element 11, and the organic EL element 11 emits light at the luminance in response to the video signal. Although the above-described light emission is generated in all the pixels belonging to one horizontal line selected by the scanning line WSL, these pixels are connected along one power source line DSL, and thus the distance from the power source to the pixel is different for each of the pixels. Therefore, in the pixel far away from the power source, the voltage supplied from the power source line DSL is reduced by a voltage drop generated by wiring resistance of the power source line DSL. In an ideal TFT, in a saturation region (region where there is no inclination of the V_{ds}-I_{d} characteristics), the value of the current I_{d} is determined only by the value of V_{gs} without depending on the value of V_{ds}, and thus the predetermined current flows to the organic EL element 11 without depending on the voltage supplied by the power source line DSL. However, in an actual TFT, there is a slight inclination of the V_{ds}-I_{d} characteristics even in the saturation region. Thus, the current I_{d} is reduced by the voltage drop of the power source line DSL, and the light emission luminance of the organic EL element 11 is reduced. Moreover, the total current value of all the pixels 11 of one horizontal line is in correlation with the total value of the video signal of all the pixels 11 of one horizontal line, and is generally different for each of the horizontal lines. Thus, since the degree of the voltage drop of the power source line DSL is different for each of the horizontal lines, even when the organic EL elements 11 emit light at the same signal level for each of the horizontal lines, the luminance variation is generated for each of the horizontal lines, and the horizontal crosstalk is generated. Thus, for the purpose of suppressing generation of the horizontal crosstalk, various measures have been taken so far to prevent the variation in the degree of the voltage drop of the power source line DSL for each of the horizontal lines.

However, it is difficult to completely eliminate the horizontal crosstalk only by correcting the voltage drop caused by the wiring resistance of the power source line DSL, and further measures have been demanded. Thus, as the result of the intensive studies, the inventors of the present application have found out that the horizontal crosstalk is generated also by the other cause. Hereinafter, the new cause will be described.

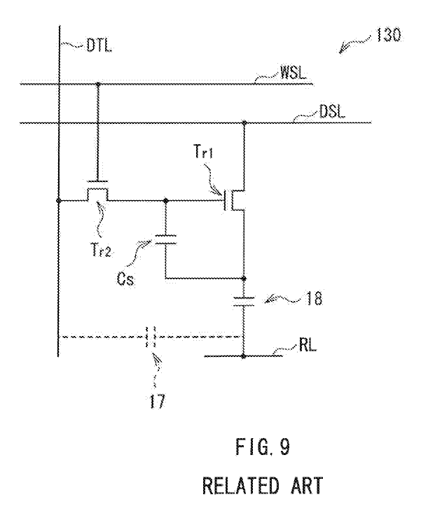

FIG. 9 illustrates an equivalent circuit of the pixel circuit array 130. As illustrated in FIG. 9, the signal line DTL and the cathode electrode 14 include a line capacity 17. During the period when a reverse bias is applied to the organic EL element 11 (for example, during the period when initialization of a Vₜₕ correction or the like is performed), the organic EL element 11 equivalently appears as a capacity component 18. Thus, even when a stable electric power is supplied to the cathode electrode terminal 15 in the display panel 10, the cathode voltage V_{ca} is changed at a pulse rise timing of the signal voltage V_{sig} inside the display panel 10 as indicated by broken line of part E of FIG. 8. With this change of the cathode voltage V_{ca}, the source voltage Vₛ is increased as indicated by broken line of part D of FIG. 8. Thus, by applying the selection pulse of the voltage Vₒₙ to the scanning line WSL, V_{gs} when the source voltage Vₛ is increased and bootstrapped is smaller than the intended voltage by V_{ca}. I_{d} is reduced by the amount by which V_{gs} is reduced, and the light emission luminance of the organic EL element 11 is reduced. At this time, as described above, the total current value of all the pixels 11 of one horizontal line is generally different for each of the horizontal lines, and thus the reduction amount of V_{gs} at the timing of the start of the light emission is different for each of the horizontal lines. Therefore, even when the organic EL elements 11 emit light at the same signal level for each of the horizontal lines, the luminance variation is generated for each of the horizontal lines, and the horizontal crosstalk is generated.

In this embodiment, measures in which the horizontal crosstalk is reduced by correcting the cathode voltage V_{ca} are taken. Specifically, the voltage generating section 29 corrects the cathode voltage V_{ca} at the predetermined timing and during the predetermined period in response to the change of the cathode voltage V_{ca} described above. At least when the organic EL element 11 starts emitting light, specifically, at the time of the bootstrap (T₁₁ of FIG. 8), the voltage generating section 29 outputs the correction voltage V_{c} corresponding to the video signal 20A of one horizontal line to the cathode electrode 14.

The period when the correction voltage V_{c} is output to the cathode electrode 14 may be from when the change of the cathode voltage V_{ca} is started to be generated (specifically, at the time of the signal pulse rise of the voltage V_{sig} on the signal line DTL) to when the bootstrap is executed (T₉ to T₁₁ of FIG. 8). The period when the correction voltage V_{c} is output to the cathode electrode 14 may be from when the selection pulse of the voltage Vₒₙ is applied to the scanning line WSL (at the time of the selection pulse rise) to when the bootstrap is executed (T₁₀ to T₁₁ of FIG. 8).

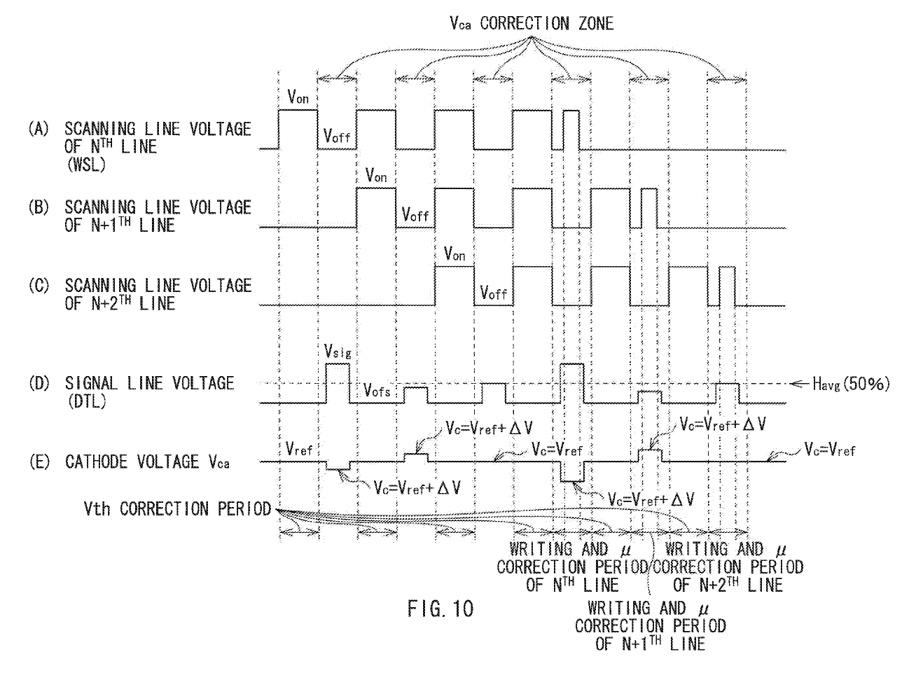

The period when the correction voltage V_{c} is output to the cathode electrode 14 may include a part of the light emission period after the bootstrap. Even in the case where the cathode voltage V_{ca} is changed by the correction voltage V_{c}, there is no influence on V_{gs} of the drive transistor Tr₁. However, as illustrated in FIG. 10, the period when the correction voltage V_{c} is output to the cathode electrode 14 is necessarily within a zone (V_{ca} correction zone) in which the Vₜₕ correction is not performed in all the pixel circuits 16 in one frame period. In the case where the cathode voltage V_{ca} is changed by the correction voltage V_{c} when the Vₜₕ correction is performed on any of the pixel circuits 16, the Vₜₕ correction is not accurately performed on that pixel circuit 16. In part D of FIG. 10, a line of the average amplitude H_{avg} when the ratio of the white display occupying one horizontal line is 50% (H_{avg} (50%)) is indicated by broken line. In part E of FIG. 10, in the case where the average amplitude H_{avg} exceeds that line or falls below that line, the state of the cathode voltage V_{ca} corrected by the correction voltage V_{c} is exemplified. Moreover, in part E of FIG. 10, in the case where average amplitude H_{avg} is identical to H_{avg} (50%), the state where the cathode voltage V_{ca} is identical to the reference potential V_{ref}, that is, the state where the cathode voltage V_{ca} is not corrected is exemplified.

Next, in the description of actions of the display device, the Vₜₕ correction will be described in detail.

### 1.3 Actions of the Display Device

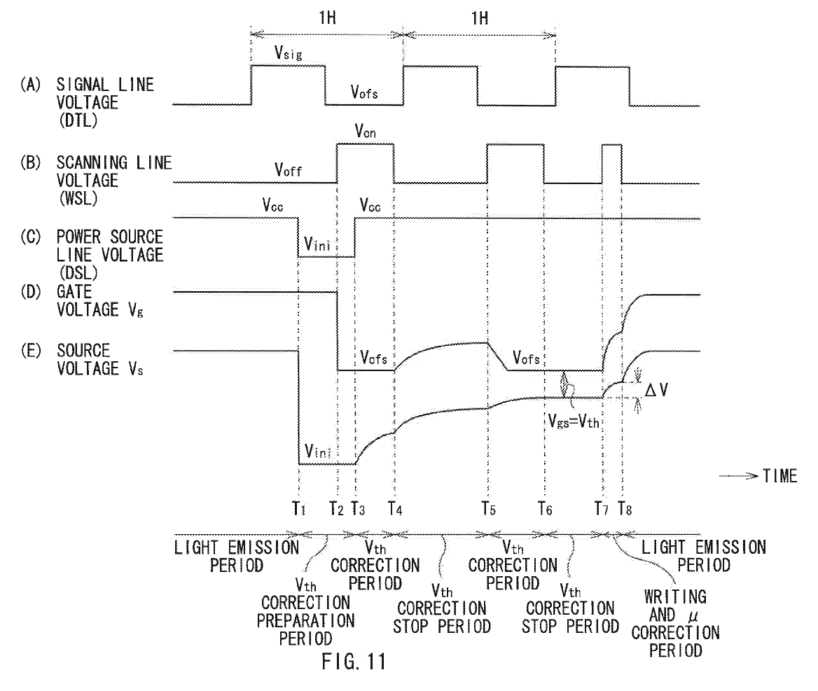

FIG. 11 illustrates an example of various waveforms when the display device 1 is driven. In part A to part C of FIG. 11, the state where V_{sig} and V_{ofs} are alternately applied to the signal line DTL, Vₒₙ and V_{off} are applied to the scanning line WSL at the predetermined timing, and V_{cc} and Vᵢₙᵢ are applied to the power source line DSL at the predetermined timing is illustrated. In part D and part E of FIG. 11, the state where the gate voltage V_{g} and the source voltage Vₛ of the drive transistor Tr₁ are momentarily changed in response to the voltage application to the signal line DTL, the scanning line WSL, and the power source line DSL is illustrated.

[Preparation Period for Vₜₕ Correction]

First, the preparation for the Vₜₕ correction is made. Specifically, the power source drive circuit 25 reduces the voltage of the power source line DSL from V_{cc} to Vᵢₙᵢ (T₁). Accordingly, the source voltage Vₛ becomes Vᵢₙᵢ, and the light of the organic EL element 11 is extinguished. Next, after the signal line drive circuit 23 switches the voltage of the signal line DTL from V_{sig} to V_{ofs}, when the voltage of the power source line DSL is Vᵢₙᵢ, the scanning line drive circuit 24 increases the voltage of the scanning line WSL from V_{off} to Vₒₙ (T₂). Accordingly, the gate voltage V_{g} is reduced to V_{ofs}.

[First Vₜₕ Correction Period]

Next, the Vₜₕ correction is performed. Specifically, when the voltage of the signal line DTL is V_{ofs}, the power source line drive circuit 25 increases the voltage of the power source line DSL from Vᵢₙᵢ to V_{cc} (T₃). Accordingly, the current I_{d} flows between the drain and the source of the drive transistor Tr₁, and the source voltage Vₛ is increased. After that, before the signal line drive circuit 23 switches the voltage of the signal line DTL from V_{ofs} to V_{sig}, the scanning line drive circuit 24 reduces the voltage of the scanning line WSL from Vₒₙ to V_{off} (T₄). Accordingly, the gate of the drive transistor Tr₁ becomes floating, and the Vₜₕ correction is stopped once.

[First Vₜₕ Correction Stop Period]

During the period when the Vₜₕ correction is stopped, sampling of the voltage of the signal line DTL is performed for a line (pixels) different from the line (pixels) on which the previous Vₜₕ correction is performed. In the case where the Vth correction is insufficient, that is, in the case where the potential difference V_{gs} between the gate and the source of the drive transistor Tr₁ is larger than the threshold voltage Vₜₕ of the drive transistor Tr₁, it is as indicated below. That is, even during the Vₜₕ correction stop period, a current I_{ds} flows between the drain and the source of the drive transistor Tr₁ in the line (pixels) on which the previous Vₜₕ correction is performed, the source voltage Vₛ is increased, and the gate voltage V_{g} is also increased by coupling through the retention capacity Cs.

[Second Vₜₕ Correction Period]

After the Vₜₕ correction stop period is finished, the Vₜₕ correction is performed again. Specifically, when the voltage of the signal line DTL is V_{ofs}, and the Vₜₕ correction is possible, the scanning line drive circuit 24 increases the voltage of the scanning line WSL from V_{off} to Vₒₙ (T₅), and the gate of the drive transistor Tr₁ is connected to the signal line DTL. At this time, in the case where the source voltage Vₛ is lower than (V_{ofs}−Vₜₕ) (the case where the Vₜₕ correction is not completed yet), the current I_{ds} flows between the drain and the source of the drive transistor Tr₁ until the drive transistor Tr₁ is cut off (until the potential difference V_{gs} becomes Vₜₕ). As a result, the retention capacity Cs is charged to Vₜₕ, and the potential difference V_{gs} becomes Vₜₕ. After that, before the signal line drive circuit 23 switches the voltage of the signal line DTL from V_{ofs} to V_{sig}, the scanning line drive circuit 24 reduces the voltage of the scanning line WSL from Vₒₙ to V_{off} (T₆). Accordingly, the gate of the drive transistor Tr₁ becomes floating, and it is possible to maintain the potential difference V_{gs} as Vₜₕ, irrespective of the magnitude of the voltage of the signal line DTL. In this manner, by setting the potential difference V_{gs} to Vₜₕ, even in the case where the threshold voltage Vₜₕ of the drive transistor Tr₁ is varied for each of the pixel circuits 16, it is possible to eliminate the variation of the light emission luminance of the organic EL element 11.

[Second Vₜₕ Correction Stop Period]

After that, during the Vₜₕ correction stop period, the signal line drive circuit 23 switches the voltage of the signal line DTL from V_{ofs} to V_{sig}.

[Writing and μ Correction Period]

After the Vₜₕ correction stop period is finished, a writing and a μ correction are performed. Specifically, when the voltage of the signal line DTL is V_{sig}, the scanning line drive circuit 24 increases the voltage of the scanning line WSL from V_{off} to Vₒₙ (T₇), and the gate of the drive transistor Tr₁ is connected o the signal line DTL. Accordingly, the gate voltage of the drive transistor Tr₁ becomes V_{sig}. At this time, the anode voltage of the organic EL element 11 is still smaller than the threshold voltage Vₑ₁ of the organic EL element 11 at this stage, and the organic EL element 11 is cut off Thus, the current I_{ds} flows to an element capacity (not illustrated in the figure) of the organic EL element 11, and the element capacity is charged. Therefore, the source voltage Vₛ is increased by ΔV, and the potential difference V_{gs} becomes V_{sig}+Vₜₕ−ΔV. In this manner, the μ correction is performed at the same time as the writing. Here, as a mobility p of the drive transistor Tr₁ is large, ΔV becomes large. Thus, by reducing the potential difference V_{gs} by ΔV before the light emission, it is possible to eliminate the variation of the mobility p for each of the pixel circuits 16.

[Light Emission]

Finally, the scanning line drive circuit 24 reduces the voltage of the scanning line WSL from Vₒₙ to V_{off} (T8). Accordingly, the gate of the drive transistor Tr₁ becomes floating, the current I_{d} flows between the drain and the source of the drive transistor Tr₁, and the source voltage Vₛ is increased. As a result, the organic EL element 11 emits light at the intended luminance.

In the display device 1 of this embodiment, as described above, by controlling on/off of the pixel circuit 16 in each pixel 12, and injecting the drive current into the organic EL element 11 of each pixel 12, a hole and an electron recombine and the light emission is generated. This light is multiply-reflected between a positive electrode and a negative electrode, and transmits the negative electrode or the like to be extracted outside. As a result, the image is displayed on the display panel 10.

### 1.4 Operations and Effects

In this embodiment, the correction voltage V_{c} corresponding to the video signal 20A of one horizontal line is applied to the cathode electrode 14 (refer to part E of FIG. 10). Thereby, when the signal voltage V_{sig} is applied to the signal line DTL, even in the case where the cathode voltage V_{ca} is changed due to the line capacity 17, it is possible to reduce the change by applying the correction voltage V_{c}. As a result, it is possible to reduce the horizontal crosstalk caused by the change of the cathode voltage V_{ca}.

In a moving image of a typical television, deterioration of image quality caused by the horizontal crosstalk is not noticed in many cases. However, in digital broadcasting of recent years, a still image with a window-like background such as data broadcasting and a display of program listing is frequently seen. In the case where such a still image is displayed, deterioration of the image quality caused by the horizontal crosstalk is obvious. Thus, in that case, it is possible to efficiently suppress the deterioration of the image quality by using the method of reducing the horizontal crosstalk of this embodiment.

Typically, in the case where the light emission luminance is increased in an organic EL display, there are a method of increasing the amplitude of the single voltage V_{sig}, and a method of increasing duty ratio of the signal voltage V_{sig}. However, when the amplitude of the signal voltage V_{sig} is increased, the influence on the cathode voltage V_{ca} is also increased, and the horizontal crosstalk is increased as a result. Meanwhile, when the duty ratio of the signal voltage V_{sig} is increased, the response speed of the moving image is deteriorated. Therefore, it is possible to increase the light emission luminance while preventing the deterioration of the image quality by using the method of reducing the horizontal crosstalk of this embodiment while increasing the amplitude of the signal voltage V_{sig}.

### 2. Modification

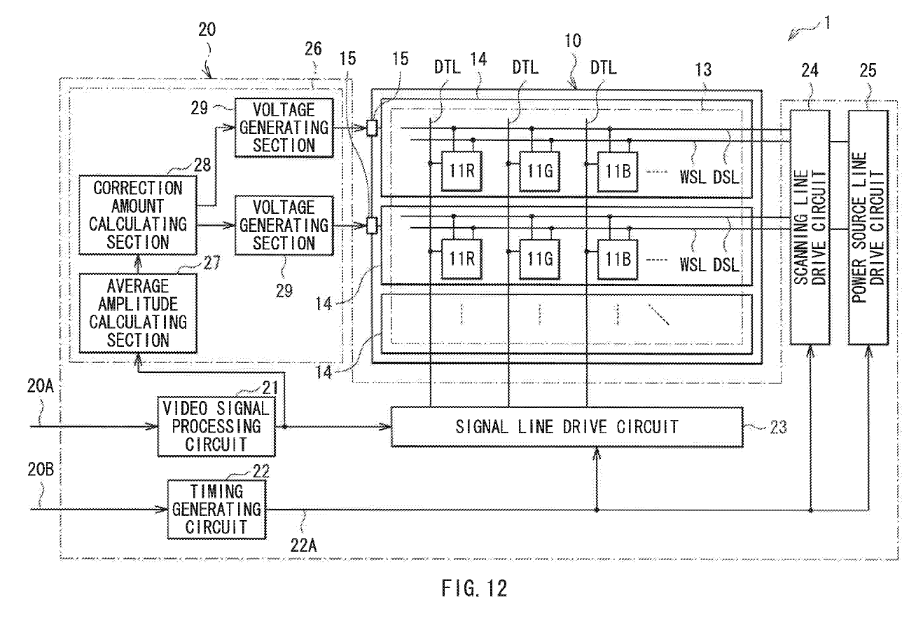

In the above embodiment, the case where the cathode electrode 14 is used as a common electrode for each of the organic EL elements 11, and is continuously formed over the whole pixel circuit array 13 (display region) is exemplified. However, it is not always necessary for the cathode electrode 14 to be as described above. For example, as illustrated in FIG. 12, the cathode electrode 14 may be formed as a separate body for each of the horizontal lines. In this case, one voltage generating section 29 is provided for each of the cathode electrodes 14, and the correction voltage Vₑ may be applied from the individual voltage generating sections 29 to the individual cathode electrodes 14. Thus, it is possible to reduce the magnitude of the current flowing to the individual cathode electrodes 14. As a result, as an electronic component used in the voltage generating section 29, it is possible to use an electronic component other than that for high current, and it is possible to reduce the component cost.

### 3. Module and Application Examples

Hereinafter, application examples of the display device which has been described in the above embodiment will be described. The display device of the above embodiment may be applied to a display device in an electronic appliance of various fields in which a video signal input from the external or a video signal generated inside the device is displayed as an image or a video, such as a television device, a digital camera, a notebook personal computer, a mobile terminal device such as a mobile phone, or a video camera.

(Module)

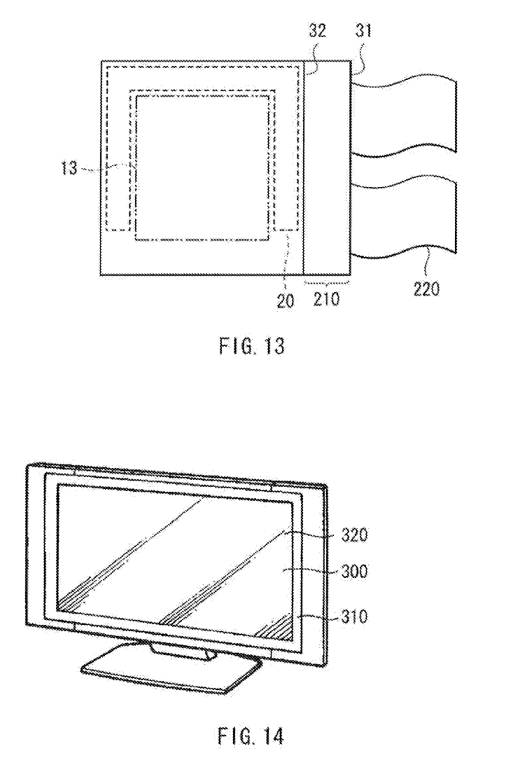

The display device of the above embodiment is, for example, installed as a module illustrated in FIG. 13 in various electronic appliances of a first application example to a fifth application example which will be described later. In this module, for example, an exposed region 210 exposed from a sealing substrate 32 is provided on one side of a substrate 31, and an external connection terminal (not illustrated in the figure) is formed by extending the wiring of the signal line drive circuit 23, the scanning line drive circuit 24, the power source line drive circuit 25, and the cathode voltage generating circuit 26 in the exposed region 210. In the external connection terminal, a flexible printed circuit (FPC) 220 may be provided for input/output of a signal.

### First Application Example

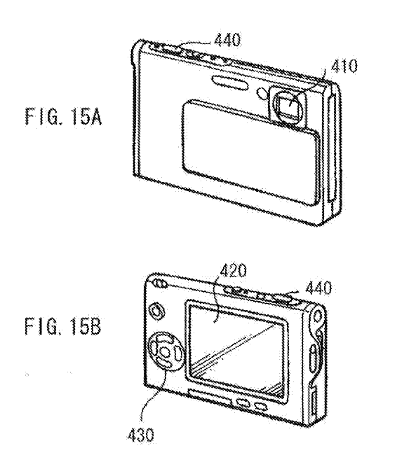

FIG. 14 illustrates an appearance of a television device to which the display device of the above embodiment is applied. The television device includes, for example, a video display screen 300 including a front panel 310 and a filter glass 320. The video display screen 300 is composed of the display device according to the above embodiment.

### Second Application Example

FIG. 15 illustrates an appearance of a digital camera to which the display device of the above embodiment is applied. The digital camera includes, for example, a light emitting section for a flash 410, a display section 420, a menu switch 430, and a shutter button 440. The display section 420 is composed of the display device according to the above embodiment.

### Third Application Example

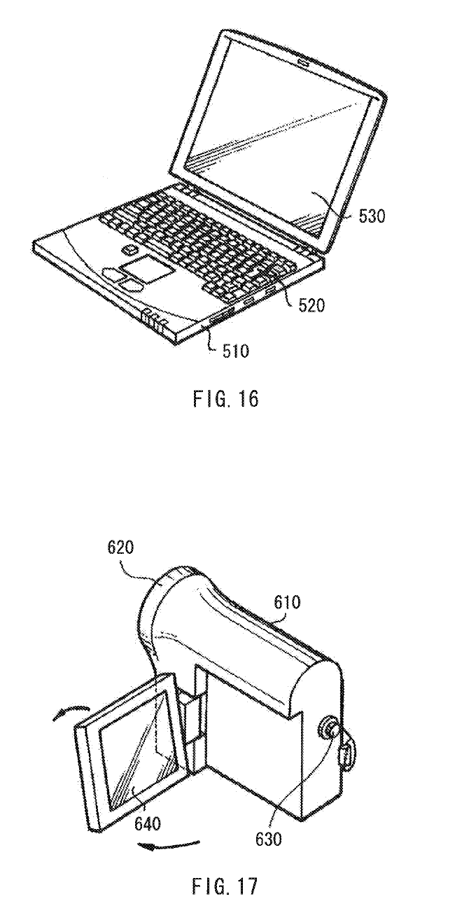

FIG. 16 illustrates an appearance of a notebook personal computer to which the display device of the above embodiment is applied. The notebook personal computer includes, for example, a main body 510, a keyboard 520 for input operation of characters and the like, and a display section 530 for displaying an image. The display section 530 is composed of the display device according to the above embodiment.

### Fourth Application Example

FIG. 17 illustrates an appearance of a video camera to which the display device of the above embodiment is applied. The video camera includes, for example, a main body 610, a lens for capturing an object 620 provided on the front side face of the main body 610, a start/stop switch in capturing 630, and a display section 640. The display section 640 is composed of the display device according to the above embodiment.

### Fifth Application Example

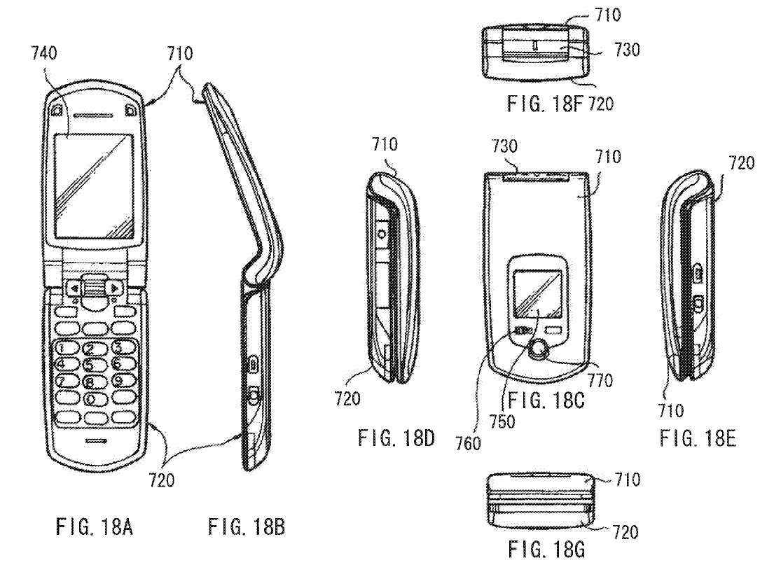

FIG. 18 illustrates an appearance of a mobile phone to which the display device of the above embodiment is applied. In the mobile phone, for example, an upper package 710 and a lower package 720 are joined by a joint section (hinge section) 730. The mobile phone includes a display 740, a sub-display 750, a picture light 760, and a camera 770. The display 740 or the sub-display 750 is composed of the display device according to the above embodiment.

The present application contains subject matter related to that disclosed in Japanese Priority Patent Application JP 2009-091535 filed in the Japan Patent Office on Apr. 3, 2009, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A display device comprising:
a plurality of light emitting elements two-dimensionally arranged in a horizontal direction and a vertical direction, and including an anode electrode, a light emitting layer, and a cathode electrode; and
a voltage generating circuit applying a correction voltage corresponding to a video signal of one horizontal line to the cathode electrode.

2. The display device according to claim 1, wherein the voltage generating circuit applies the correction voltage to the cathode electrode at least before the light emission of the light emitting element is started.

3. The display device according to claim 1, further comprising:
a pixel circuit array including a plurality of signal lines, a plurality of scanning lines, and a plurality of power source lines, and driving the light emitting element, wherein
the voltage generating section includes
a calculating section calculating, from the video signal, an average amplitude of a signal voltage of one horizontal line output to the plurality of signal lines, and then calculating, from the average amplitude, the correction voltage, and
a voltage generating section generating the correction voltage, and applying the correction voltage to the cathode electrode.

4. The display device according to claim 3, wherein
the calculating section includes an LUT (lookup table) associating information on the average amplitude and a correction amount to a reference voltage in the cathode electrode, extracts, from the LUT, a correction amount corresponding to the average amplitude calculated from the video signal, and calculates the correction voltage based on the extracted correction amount and the reference voltage.

5. The display device according to claim 3, wherein
the calculating section generates a digital signal corresponding to the calculated correction voltage, and outputs the digital signal to the voltage generating section, and
the voltage generating section comprises:
a D/A convertor converting the digital signal into an analogue signal, and outputting the analogue signal; and
a constant voltage circuit generating a voltage corresponding to the analogue signal as the correction voltage, and applying the correction voltage to the cathode electrode.

6. The display device according to claim 1, wherein the cathode electrode is formed as an electrode used in common for all of the plurality of light emitting elements.

7. The display device according to claim 1, wherein the cathode electrode is formed as a separate body for each of the horizontal lines.
